(19) United States
(12) Patent Application Publication
(10) Pub. No.: US 2005/0256733 A1
(43) Pub. Date: Nov. 17, 2005

(54) Hairstyle displaying system, hairstyle displaying method, and computer program product

(75) Inventors: Yuki Nagai, Tokyo (JP); Kuniko Ushiro, Tokyo (JP); Yoshiro Matsunami, Tokyo (JP); Tsuyoshi Hashimoto, Tokyo (JP); Yuusuke Kojima, Tokyo (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/123,216

(22) Filed: May 6, 2005

(30) Foreign Application Priority Data
May 14, 2004 (JP) 2004-145094

(51) Int. Cl. G06F 17/60

(52) U.S. Cl. 705/1

(57) ABSTRACT

A hairstyle displaying system stores a hairstyle data for indicating a plurality of types of hairstyles, and a coloring data for indicating a plurality of types of hair colors, in a style content database. Individual data which constitutes the hairstyle data or the coloring data is managed with change-over-time data, which indicates the state of a change over time. Moreover, these data are also associated with predetermined feature parameters, which define the features of a head portion of a customer. For example, after hair treatments at a beauty shop, the hairstyle displaying system generates and displays a future image, which shows how the current hairstyle and hair color will change as time passes, with respect to the customer.

### BACKGROUND OF THE INVENTION

1. Field of the Invention

The present invention relates to a hairstyle displaying system, a hairstyle displaying method, and a computer program product.

2. Description of the Related Art

If having their hair cut at a beauty shop (or a hair salon) a barber shop or the like, most of the time, customers select desired hairstyles from magazines and hair catalogs prepared in advance. In this method, quite a few customers make complaints about the hairstyles after the hair cut. This results from that the understanding of stylists does not match that of the customers. Thus, there are suggested techniques for reducing such complaints (refer to Japanese Patent Application Laying Open NO. 2001-344492, Japanese Patent Application Laying Open NO. 2002-328995, Japanese Patent Application Laying Open NO. 2000-231623, and Japanese Patent Application Laying Open NO. 2001-217149, for example).

According to a beauty shop selecting system described in Japanese Patent Application Laying Open NO. 2001-344492 (hereinafter referred to as a first conventional technique), if a search condition, such as a hairstyle, is inputted from an information terminal owned by a customer, a searching device searches for a beauty shop which satisfies the search condition, from a database in which shop information, stylist information, and the like are stored. Therefore, it describes that the customer can select the beauty shop at which the desired hairstyle is satisfied.

Moreover, according to a hairstyle simulation system described in Japanese Patent Application Laying Open NO. 2002-328995 (hereinafter referred to as a second conventional technique), it has a hairstyle database in which a plurality of hairstyle samples are stored, and a user database in which picture data about users' head portions are stored. It describes that only by inputting the image of a hairstyle desired by a user, the user can look at a hairstyle that matches the image. It also describes that by combining the hairstyle with the picture data of the user, the user can confirm whether or not the hairstyle suits the self. Incidentally, a technique in which the confirmation is possible is also disclosed in Japanese Patent Application Laying Open NO. 2000-231623 (hereinafter referred to as a third conventional technique) or Japanese Patent Application Laying Open NO. 2001-217149 (hereinafter referred to as a fourth conventional technique).

Such techniques, however, have the following problems.

In the first conventional technique, it is only possible to select the beauty shop depending on hairstyles. It is impossible to confirm whether or not the searched hairstyle suits the customer himself or herself. Moreover, in the second, third and fourth techniques, it is only possible that the customer subjectively confirms consistency with his or her desired hairstyle, and it is difficult for the customer to confirm whether or not the hairstyle really suits the self. Namely, in such conventional techniques, it is difficult for the customer to find out the hairstyle that suits the self.

In addition, according to the conventional techniques, it is uncertain what the hairstyle and the hair color will be like one month or two months after the actual hair treatments or the like at the hair salon or the like, or what the hairstyle and the hair color will be like at the time point of an important event or a party which will be held several weeks after the hair treatments. Moreover, if the hair treatments are not performed now at the hair salon or the like, or if the customer does not go to the hair salon, it is uncertain what the hairstyle and the hair color will be like after an elapse of one month, two months, or the like. As a result, whether the customer receives the hair treatments without anxiety at the hair salon or the like or not, there are difficulties in a way. It is also not always easy for a hairdresser or the like to consult with, give advice, and give comments to the customer. According to the conventional techniques as described above, there is such a technical problem that the information about hair or hair treatments, which is individually and specifically helpful and which is provided for each customer at the hair salon or the like, is not necessarily sufficient.

### SUMMARY OF THE INVENTION

It is therefore an object of the present invention to provide a hairstyle displaying system and a hairstyle displaying method which can visually and accurately provide information about hair or hair treatments, which is individually and specifically helpful, for each customer at a hair salon or the like, as well as a computer program product which makes a computer function as the hairstyle displaying system.

<Hairstyle Displaying System>

The above object of the present invention can be achieved by a first hairstyle displaying system provided with: an image pickup device for imaging one customer; a current image data generating device for generating current image data which indicates a current hair state of the imaged one customer; a future image data generating device for generating future image data which indicates a future hair state of the one customer after an elapse of a predetermined period, on the basis of the generated current image data; and a displaying device for displaying the generated future image data.

According to the first hairstyle displaying system of the present invention, at first, one customer is imaged or photographed by the image pickup device, such as a digital camera, at a treatment room or a counseling room of a hair salon, at the customer's place after the customer gets home from the hair salon, or the like. Alternatively, the customer may be imaged at a waiting room or a counseling room of the hair salon, at the customer's place before the customer goes to the hair salon, or the like. At the time of the imaging or photographing, preferably, the head portion and the hair portion of the one customer are mainly imaged, manually or automatically, so that the hairstyle and the hair color can be seen well.

Then, the current image data, which indicates a current hair state of the imaged one customer, is generated by the current image data generating device, such as a digital camera, a portable apparatus, and a personal computer. The hair state of the present invention typically means at least one of the hairstyle and the hair color, and preferably both. As the hair state, it is also possible to treat an element other than the hairstyle and the hair color in appearance, which is associated with hair and which can be imaged.

Next, the future image data, which indicates a future hair state of the one customer after an elapse of the predetermined period, is generated, on the basis of the current image data generated in the above manner, by the future image data generating device, such as a personal computer, a work station, a server apparatus, a client apparatus, a terminal apparatus, a portable apparatus, and a digital camera. Here, the future image data for indicating the future hairstyle after the elapse of the predetermined period, such as an elapse of one day, one week or one month, is generated by the future image data generating device. Alternatively, the future image data for indicating the future hair color after the elapse of the predetermined period is generated. Alternatively, the future image data which indicates both the hairstyle and the hair color after the elapse of the predetermined period is generated. As a method of specifying or setting the “predetermined period”, the “predetermined period” may be fixed to a default value set in advance. A desired value may be selected by an inputting device, such as a keyboard, a mouse, ten keys, an audio inputting apparatus, and a touch panel, from a plurality of values which are set in advance. Alternatively, a desired value may be inputted via the inputting device. Typically, after the elapse of the predetermined period, the hair grows long in the hairstyle, and the color fades in the hair color, and a permanent wave becomes loose. The future image data as described above can be generated by various technical methods, such as data search, data estimation, function processing, and simulation, as described in detail in the aspects of the present invention later.

Then, the future image data generated in the above manner is displayed by the displaying device, which is, for example, a large monitor constructed from a plasma display, a liquid crystal display, a Cathode Ray Tube (CRT), or the like, or a small monitor constructed from a liquid crystal display, an organic EL display, or the like. With respect to the future image data, preferably, the head portion and the hair portion of the one customer are mainly displayed so that the hairstyle and the hair color can be seen well. Moreover, from the viewpoint of the display of the hair color, color display is desirable; however, black-and-white display is also allowed. Incidentally, the future image data displayed in this manner may be printed by a printing device, such as a printer, together with the current image data, or independently.

Therefore, from the standpoint of one customer, it is possible to know in advance what the hair state (i.e. the hairstyle and the hair color) will be like several days, several weeks, or several months after the treatments of the own hair at the hair salon or the like. For example, it is possible to know how much the hair color fades or gets close to a desired color after the elapse of the predetermined period. For example, it is possible to know how long the hair will grow, and in accordance with that, it is possible to know in what color the hair around the root will be. For example, it is possible to know how loose the perm will be, or what kind of permanent wave the customer will have in the hairstyle. Alternatively, it is possible to know how long the hair will grow and what the hairstyle will be like as a whole, for example. Moreover, it is possible to visually confirm what the hairstyle and the hair color will be like on a special day, such as a wedding ceremony and a recital which are coming up after the hair treatments.

Incidentally, the imaging or photographing is not limited to “after the treatments” of own hair at the hair salon or the like. It may be performed “before the treatments”, to thereby generate the future image data on the basis of the current hairstyle and the hair color. Even in this case, it is possible to see the hairstyle and the hair color after the elapse of the predetermined period. Thus, it is possible to visually confirm what the hairstyle and the hair color will be like on a special day, such as a wedding ceremony and a recital, if the customer does not go to the hair salon. Moreover, the present invention is helpful even as a tool for counseling at the hair salon. Apart from that, it is considered there is various utility similar to that in the case of the imaging after the hair treatments described above.

On the other hand, from the standpoint of the hair salon, the present invention is useful as a tool for supporting their explanations, such as “you will have the desired hairstyle or hair color in several days or in several weeks from now”, with respect to complaints from the customer, such as “this hairstyle or hair color is not what I want” after the hair treatments. Moreover, on the basis of the future image data, it is possible to give some advice and comments about the future hair treatments for the customer. Furthermore, it is possible to rouse the customer's next visit by setting an annual plan corresponding to various events of the customer, so that the present invention is also extremely useful as a business tool.

As described above, according to the first hairstyle displaying system of the present invention, it is possible to visually and accurately provide the information about hair or hair treatments, which is individually and specifically helpful, for each customer at a hair salon or the like.

In one aspect of the first hairstyle displaying system of the present invention, it is further provided with: a database for storing therein a plurality of sample image data, which individually indicate different hair states, as a pair or a group having a relationship which corresponds to before and after the elapse of the predetermined period or a unit period, by associating before the elapse with after the elapse, one to one, multiplicity to one, one to multiplicity, or multiplicity to multiplicity, the future image data generating device searching the database for sample image data corresponding to what the hair state shown by the generated current image data will be like after the elapse of the predetermined period, on the basis of the generated current image data, and generating the future image data on the basis of the searched sample image data.

According to this aspect, the plurality of sample image data, which individually indicate different hair states, are stored in the database in advance. Particularly, the plurality of sample image data are stored as a pair or a group having a relationship which corresponds to before and after the elapse of the “predetermined period” or a unit period, by associating before the elapse with after the elapse, one to one, multiplicity to one, one to multiplicity, or multiplicity to multiplicity. For example, if there is one sample image data for indicating one hair color as an initial state, there is also stored another sample image data for indicating a hair color to which the hair color of the initial state fades after the elapse of the predetermined period. Moreover, the both sample image data are stored with them associated as before and after the elapse of the predetermined period. For example, if there is one sample image data for indicating one hairstyle as an initial state, there is also stored another sample image data for indicating a hairstyle to which the hairstyle of the initial state changes, in response to the growth of hair, after the elapse of the predetermined period. Moreover, the both sample image data are stored, with them associated as before and after the elapse of the predetermined period. Moreover, with respect to one hair color and one hairstyle, the sample image data for indicating the hair states before and after an elapse of each unit period of 10 days, e.g., after an elapse of 10 days, 20 days, 30 days, and the like, may be stored in association with each other.

Then, in displaying the future image data, the sample image data corresponding to what the hair state shown by the generated current image data will be like after the elapse of the predetermined period, is searched for from the database by the future image data generating device. For example, at first, one sample image data which corresponds to or is considered, from a predetermined standard, to be the most similar to the current image data is searched for. Moreover, on the database, another sample image data which is associated with the searched one sample image data as being the data after the elapse of the predetermined period or the unit period is searched for. Then, on the basis of the another sample image data searched for in this manner, the future image data is generated. For example, the image data is combined such that the hairstyle and the hair color shown by the current image data is replaced by the hairstyle and the hair color shown by the searched another sample image data. In other words, an image portion except the hair of the one customer included in the current image data is combined with an image portion of the hair shown by the searched sample image data, to thereby generate the future image data.

Therefore, as long as the sample image data of many hairstyles and hair colors is prepared in the database in advance, it is possible to certainly and easily search for the sample image data corresponding to those before and after the elapse of the predetermined period. Thus, it is possible to certainly and easily generate the future image data.

Incidentally, even due to the differences of each customer, such as a hair condition, age, and the content of treatments, the relationship between the sample image data before and after the predetermined period can change. In this case, however, it is enough if the database is searched on the future image data generating device by using the hair condition and the like as parameters. Namely, in this case, the plurality of sample image data are stored, as a pair or a group having a relationship which corresponds to before and after the elapse of the predetermined period or the unit period, by associating before the elapse with after the elapse, multiplicity to one, one to multiplicity, or multiplicity to multiplicity. However, it is enough if the future image data having a one-to-one correspondence relationship with the current image data is searched for in the end by conditional branching with the hair condition and the like as parameters. Alternatively, a plurality of types of future image data may be generated for each of the parameters of the hair condition and the like. Moreover, for simplicity, it is possible to build the database with disregard to the hair condition and the like. In this case, the search processing and the generation processing of the future image data are easy. For example, the future image data in which only the hair color is simply different from the color in the current image data is associated with the current image data on the database, and the future image data in which only the hair color is simply different may be searched for by the future image data generating device. Alternatively, the future image data in which the hair color only at the root of hair simply changes to black is associated with the current image data on the database, and this future image data may be searched for. For example, the future image data in which only the length of hair is longer is associated with the current image data on the database, and this future image data may be searched for. Then, the future image data generated by using the search processing as described above is displayed by the displaying device.

Alternatively, in another aspect of the first hairstyle displaying system of the present invention, it is further provided with: a database for storing therein a plurality of sample image data, which individually indicate different hair states, as a pair or a group having a relationship which corresponds to before and after the elapse of the predetermined period or a unit period, by associating before the elapse with after the elapse, one to one, multiplicity to one, one to multiplicity, or multiplicity to multiplicity, the future image data generating device having an estimating device for estimating the future image data corresponding to the current image data, on the basis of the sample image data stored in the database and the predetermined period, to thereby generate the future image data.

According to this aspect, the database is used as a so-called “knowledge base”, and the estimating device is used as a so-called “inference engine”. By this, the future image data corresponding to the current image data is estimated on the basis of the sample image data stored in the database and the predetermined period. Even due to the differences of each customer, such as a hair condition, age, and the content of treatments, the relationship between the sample image data before and after the predetermined period can change. In this case, however, it is enough if the inference or estimation is performed on the future image data generating device by using the hair condition and the like as parameters. Namely, in this case, the plurality of sample image data are stored, as a pair or a group having a relationship which corresponds to before and after the elapse of the predetermined period or the unit period, by associating before the elapse with after the elapse, multiplicity to one, one to multiplicity, or multiplicity to multiplicity. However, it is enough if the future image data having a one-to-one correspondence relationship with the current image data is estimated in the end by algorithm with the hair condition and the like as parameters. Alternatively, a plurality of types of future image data may be generated for each of the parameters of the hair condition and the like. Moreover, for simplicity, it is possible to build the database with disregard to the hair condition and the like. In this case, the inference or estimation processing and the generation processing of the future image data are easy. Incidentally, the estimation function provided for the future image data generating device as described above may have a so-called “learning function”. Then, the future image data generated by using the estimation or inference processing as described above is displayed by the displaying device.

Alternatively, in another aspect of the first hairstyle displaying system of the present invention, the future image data generating device calculates a plurality of data elements constituting the future image data, as a predetermined function of a plurality of quantitative data elements constituting the current image data, and generates the future image data as a set of the calculated plurality of data elements.

According to this aspect, the current image data is constructed from the plurality of quantitative data elements. For example, the plurality of quantitative data elements are: quantitative data which defines the coordinates of the root and the end of each hair or a hair bundle and which defines a segment of them in vectors or scalars; quantitative data which digitizes and shows the hair color in gradation, brightness, lightness, and the like; and so on. Then, the plurality of data elements constituting the future image data is calculated by the future image data generating device, as the predetermined function of the quantitative data elements, as described above. For example, with respect to each hair or a hair bundle, a calculation is performed such that the hair grows depending on the predetermined period, or a calculation is performed such that the segment between the rood and the end is extended depending on the predetermined period. Alternatively, a calculation is performed such that the hair color approaches black in graduation or the hair color in a certain range near the root partially approaches black, depending on the predetermined period. The predetermined function of the quantitative data is calculated in this manner, and the future image data is constructed again as the set of the data elements of the calculated result. Then, the future image data generated by using the function processing or calculation processing, as described above, is displayed by the displaying device.

In another aspect of the first hairstyle displaying system of the present invention, the future image data generating device is included in a network and provided for a server communicable via the network, the image pickup device, the current image data generating device, and the displaying device are included in the network and provided for a client which can communicate with the server via the network, the server transmits the generated future image data via the network, the client receives the transmitted future image data, and the displaying device displays the received future image data.

According to this aspect, the server and the client are included in the network, such as the Internet and an intranet. The client is, for example, a personal computer or a workstation provided at the hair salon or the customer's place, or a portable apparatus of the customer, a cell phone, or the like. Moreover, the server is, for example, a personal computer provided at an information service company, a small, middle-sized, or large computer, or the like. In operation of the first hairstyle displaying system, on the client, the imaging is performed by the image pickup device, and the current image data generated by the current image data generating device in response to the imaging is transmitted to the server via the network. Then, on the server, the future image data is generated by the future image data generating device. At this time, a database or the like required for the generation of the future image data is provided for the server, preferably. Then, on the server, the future image data generated by the future image data generating device is transmitted to the client via the network. On the client, the transmitted future image data is received and displayed by the displaying device. Therefore, it is enough if the generation of the future image data, which has a large processing load, is performed on the server side. Thus, as for the client provided at the hair salon and the customer's place or the like, a relatively simple apparatus will do, such as a personal computer and a cell phone, so that it is useful in practice. Incidentally, the client is not necessarily one. For example, the current image data may be transmitted from one client to the server, and the future image data may be transmitted to the server to other clients.

Alternatively, in another aspect of the first hairstyle displaying system of the present invention, it is further provided with: a database for storing therein a plurality of sample image data, which individually indicate different hair states, in association with feature parameters for indicating predetermined types of features associated with a hair state of an arbitrary customer; a specifying device for specifying at least one of the feature parameters corresponding to at least one of the features associated with the future image data; a searching device for searching for sample image data which matches the specified at least one of the feature parameters, from the sample image data stored in the first database; and an image generating device for generating an image of suggestion to be suggested to one customer in the future, on the basis of the searched sample image data, the displaying device further displaying the generated image of suggestion.

According to this aspect, the plurality of sample image data is stored in the database in advance, in such a form that the sample image data are individually associated with the feature parameters. In operation of the second hairstyle displaying system, if the future image data is generated, at least one of the feature parameters corresponding to at least one of the features associated with the future image data is specified by the specifying device, such as a personal computer. At least one of the feature parameters is specified by an image recognition method for the future image data, such that the face shape=oval, the hair condition=hard, the hair volume=much, and the like. Then, the sample image data which matches the at least one of the feature parameters specified in this manner is searched for from the sample image data stored in the database, by the searching device, such as a personal computer. Moreover, the image of suggestion to be suggested to the one customer in the future is generated on the basis of the sample image data searched for in this manner, by the image generating device, such as a personal computer. In the end, the image of suggestion is displayed on the displaying device.

Therefore, if the hairstyle and the hair color of one customer change to those shown by the future image data in the future, the hairstyle and the hair color which will be recommended at the time point of the future can be suggested in advance. For example, it is possible to promote, one week or one month after the hair treatments, the hairstyle and the hair color which will be recommended in the next treatments, which is two months or three months after the hair treatments, in such a form that the image of suggestion is displayed.

In this aspect, the image generating device may generate the image of suggestion, on the basis of the searched sample image data and the generated current image data.

By virtue of such construction, the image of suggestion is generated by the image generating device on the basis of the sample image data and the current image data. For example, the image of suggestion is generated by combining (i) the image data of the hairstyle and the hair color in the sample image data and (ii) the image data portion except hair, such as the face and head portion of the customer, associated with the current image data. As a result, it is possible to construct the image of suggestion as an image full of a realistic sensation depending on each customer.

In the case of such construction, moreover, the first hairstyle displaying system may be further provided with: a date managing device for managing at least a date when the one customer is imaged by the image pickup device; and a transmitting/announcing device for transmitting or announcing the generated image of suggestion on a date or on a date and time determined on the basis of the managed date.

By virtue of such construction, in imaging one customer, at least the date when the one customer is imaged is managed by the date managing device. Here, “at least the date” indicates the possibility of managing not only the date but also the date and time. Then, on the date or the date and time determined on the basis of the managed date, for example, one week or one month after the date of the imaging, the image of suggestion generated by the image generating device is transmitted or announced by the transmitting/announcing device, such as a personal computer, through the network or by mail, or the like. At this time, the future image data may be transmitted or announced, together with the image of suggestion. Moreover, the generation of the image of suggestion by the image generating device may be performed in the imaging without delay, or may be performed at the time of the transmission or the announcement. As a result, it is possible to transmit or announce the image of suggestion which is promoted, to the one customer, in proper timing with an eye on the next treatments after the previous treatments at the hair salon or the like. The present invention is extremely useful as a business tool for the hair salon or the like.

In the case of such construction, moreover, it may be constructed such that the future image data generating device, the specifying device, the database, the searching device, the image generating device, and the transmitting/announcing device are included in a network and provided for a server communicable via the network, the image pickup device, the current image data generating device, and the displaying device are included in the network and provided for a client which can communicate with the server via the network, the server transmits the image of suggestion via the network, the client receives the transmitted image of suggestion, and the displaying device displays the received image of suggestion.

According to such construction, the server and the client are included in the network, such as the Internet and an intranet. The client is, for example, a personal computer or a workstation provided at the hair salon or the customer's place, or a portable apparatus of the customer, a cell phone, or the like. Moreover, the server is, for example, a personal computer provided at an information service company, a small, middle-sized, or large computer, or the like. In operation of the first hairstyle displaying system, on the client, the imaging is performed by the image pickup device, and the current image data generated by the current image data generating device in response to the imaging is transmitted to the server via the network. Then, on the server, the future image data is generated by the future image data generating device. Then, on the server, the image of suggestion is generated on the basis of the future image data, by the specifying device, the searching device, and the image generating device. The image of suggestion is transmitted to the client via the network. On the client, the transmitted image of suggestion is received, and displayed by the displaying device. Therefore, it is enough if the generation of the future image data, which has a large processing load, is performed on the server side. Thus, as the client provided at the hair salon and the customer's place or the like, a relatively simple apparatus will do, such as a personal computer and a cell phone, so that it is useful in practice. Incidentally, the client is not necessarily one. For example, the current image data may be transmitted from one client to the server, and the image of suggestion may be transmitted to the server to other clients.

The above object of the present invention can be also achieved by a second hairstyle displaying system provided with: a database for storing therein a plurality of sample image data, which individually indicate different hair states, in association with feature parameters for indicating predetermined types of features associated with a hair state of an arbitrary customer; a specifying device for specifying at least one of the feature parameters corresponding to at least one of the features associated with one customer; a searching device for searching for sample image data which matches the specified at least one of the feature parameters, from the sample image data stored in the first database; an image generating device for generating an image of suggestion to be suggested to the one customer in the future, on the basis of the searched sample image data, a displaying device for displaying the generated image of suggestion; and a future image data generating device for generating future image data which indicates a future hair state after an elapse of a predetermined period, from a hair state shown by the generated image of suggestion, the displaying device further displaying the generated future image data at the same time of, or before or after displaying the image of suggestion.

According to the second hairstyle displaying system of the present invention, the plurality of sample image data is stored in such a form that the sample image data are individually associated with the feature parameters. In operation of the second hairstyle displaying system, at least one of the feature parameters corresponding to at least one of the features associated with one customer is specified by the specifying device, such as a personal computer. At least one of the feature parameters is specified by an image recognition method for the current image data obtained by imaging the one customer or by inputting parameters via an inputting device, such as a keyboard, such that the face shape=oval, the hair condition=hard, the hair volume=much, and the like. Then, the sample image data which matches the at least one of the feature parameters specified in this manner is searched for from the sample image data stored in the database, by the searching device, such as a personal computer. Moreover, the image of suggestion to be suggested to the one customer in the future is generated on the basis of the sample image data searched for in this manner, by the image generating device, such as a personal computer. Then, the image of suggestion is displayed on the displaying device. At the same time of, or before or after displaying the image of suggestion, the future image data for indicating the future hair state after the elapse of the predetermined period is generated from the hair state shown by the image of suggestion, by the future image data generating device, such as a personal computer, and is displayed by the displaying device. Incidentally, with respect to the generation of the future image data by the future image data generating device, it is possible to adopt the same various methods as those in the first hairstyle displaying system of the present invention described above.

Therefore, from the standpoint of one customer, it is possible to visually confirm not only the image of suggestion immediately after the hair treatments if some types of treatments are performed, but also the hairstyle and the hair color after the elapse of the predetermined period, such as one week, one month, or three months after the hair treatments. For example, before the actual hair coloring, it is possible to know how much the hair color fades or gets close to a desired color after the elapse of the predetermined period. For example, it is possible to know what kind of change will occur in the hair color around the rood of hair. For example, before the actual hair perm, it is possible to know how loose the perm will be, or what kind of permanent wave the customer will have in the hairstyle after the elapse of the predetermined period. Alternatively, before the actual hair cut, it is possible to know how long the hair will grow and what the hairstyle will be like as a whole after the elapse of the predetermined period, for example. Particularly, it is possible to confirm what the hairstyle and the hair color will be like on a special day, such as a wedding ceremony and a recital which are coming up after the hair treatments, before the actual hair treatments. As described above, the present invention is extremely helpful as a tool for counseling at the hair salon or the like.

As described above, according to the second hairstyle displaying system, it is possible to visually and accurately provide the information about hair or hair treatments, which is individually and specifically helpful, for each customer at a hair salon or the like.

Incidentally, the image of suggestion and the future image data displayed in this manner may be printed by a printing device, such as a printed.

In addition, in response to various aspects in the above-described first hairstyle suggesting system of the present invention, the second hairstyle suggesting system of the present invention can also adopt various aspects.

<Hairstyle Displaying Method>

The above object of the present invention can be also achieved by a hairstyle displaying method provided with: an image pickup process of imaging one customer; a current image data generating process of generating current image data which indicates a current hair state of the imaged one customer; a future image data generating process of generating future image data which indicates a future hair state of the one customer after an elapse of a predetermined period, on the basis of the generated current image data; and a displaying process of displaying the generated future image data.

According to the hairstyle displaying method of the present invention, it is provided with: the imaging process; the current image data generating process; the future image data generating process; and the displaying process. Thus, it is possible to obtain the same operation effects as in the first hairstyle displaying system of the present invention described above, and it is possible to visually and accurately provide the information about hair or hair treatments, which is individually and specifically helpful, for each customer at the hair salon or the like.

Incidentally, in response to various aspects in the above-described first hairstyle suggesting system of the present invention, the hairstyle suggesting method of the present invention can also adopt various aspects.

<Computer Program Product>

The above object of the present invention can be also achieved by a computer program product in a computer-readable medium for tangibly embodying a program of instructions executable by a computer to make the computer function as the above-described first or second hairstyle displaying system (including its various aspects). More specifically, the computer program product makes the computer function as the at least one portion of the imaging device, the current image data generating device, the future image data generating device, the displaying device, the specifying device, the database, the searching device, the image generating device, the transmitting/announcing device in the first or second hairstyle displaying system described above.

According to the computer program product of the present invention, the above-described first or second hairstyle displaying system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described first or second hairstyle displaying system.

For example, by installing application software for generating the image data to a personal computer which is the client, it is possible to generate the data, such as the future image of the present invention, only on the client without the network.

Incidentally, in response to various aspects in the above-described first hairstyle suggesting system of the present invention, the computer program product of the present invention can also adopt various aspects.

The nature, utility, and further features of this invention will be more clearly apparent from the following detailed description with reference to preferred embodiments of the invention when read in conjunction with the accompanying drawings briefly described below.

As explained above, according to the first hairstyle displaying system of the present invention, it is provided with: the image pickup device; the current image data generating device; the future image data generating device; and the displaying device. According to the second hairstyle displaying system of the present invention, it is provided with: the database; the specifying device; the searching device; the image data generating device; the displaying device; and the future image data generating device. According to the hairstyle displaying method of the present invention, it is provided with: the image pickup process; the current image data generating process; the future image data generating process; and the displaying process. Thus, it is possible to visually and accurately provide the information about hair or hair treatments, which is individually and specifically helpful, for each customer at the hair salon or the like.

### BRIEF DESCRIPTION OF THE DRAWINGS

FIG. 1 is a conceptual diagram showing a hairstyle displaying system in an embodiment of the present invention;

FIG. 2 is a block diagram showing a terminal system in the hairstyle displaying system;

FIG. 3 is a block diagram showing a server in the hairstyle displaying system;

FIG. 4 is a schematic diagram showing a customer chart;

FIG. 5 is a flowchart showing a counseling service performed by using the hairstyle displaying system;

FIG. 6 is a flowchart showing change-over-time processing in the counseling service; and

FIG. 7 is a flowchart showing an aftercare service performed by using the hairstyle displaying system.

### DETAILED DESCRIPTION OF THE PREFERRED EMBODIMENT

The embodiment of the present invention will be explained with reference to the drawings hereinafter.

<Structure of Embodiment>

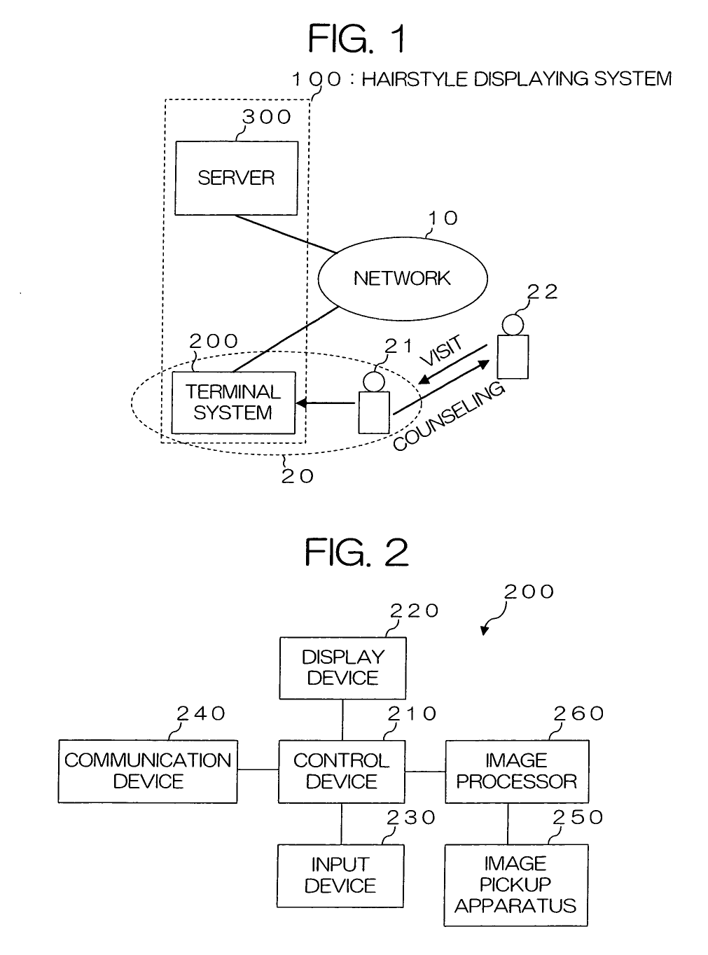

At first, with reference to FIG. 1, the structure of a hairstyle displaying system in the embodiment of the present invention will be explained. FIG. 1 shows a hairstyle displaying system 100.

In FIG. 1, the hairstyle displaying system 100 is provided with: a terminal system 200; and a server 300, both of which are individually connected to a network 10.

The network 10 is a wide area network, represented by an Internet environment or the like which uses a general phone line, ADSL (Asymmetric Digital Subscriber Line), or the like, for example. Incidentally, the network 10 may be a LAN (Local Area Network), represented by the Ethernet (registered trademark) standard.

The terminal system 200 is one example of the “client” of the present invention. The terminal system 200 is installed at a beauty shop 20, and can communicate with the server 300 via the network 10. In the terminal system 200, for example, a stylist 21 who works for the beauty shop 20 can provide various counseling described later for a customer 22 who comes to the beauty shop 20. Incidentally, the customer 22 in the embodiment indicates one of the general public customers who come to the beauty shop 20.

Now, with reference to FIG. 2, the detailed structure of the terminal system 200 will be explained. FIG. 2 shows the terminal system 200.

In FIG. 2, the terminal system 200 is provided with: a control device 210; a display device 220; an input device 230; a communication device 240; an image pickup apparatus 250; and an image processor 260.

The control device 210 is provided with a Central Processing Unit (CPU) or the like, for example. The control device 210 can control the operation of each device described later of the terminal system 200.

The display device 220 is a large monitor constructed from a plasma display, a liquid crystal display, a Cathode Ray Tube (CRT), or the like, or a small monitor constructed from a liquid crystal display, an organic EL display, or the like. Incidentally, the display device 220 is one example of the “displaying device” of the present invention. The display device 220 can display an image transmitted from the server 300 when the counseling is provided for the customer 22.

The input device 230 is a pointing device, such as a keyboard, ten keys, and a mouse. The stylist 21 can input information about the customer 22 and various information about the counseling, through the input device 230.

The communication device 240 is a modem or the like, for example. The communication device 240 allows the data to be transmitted and received between the terminal system 200 and the server 300.

The image pickup apparatus 250 is one example of the “image pickup device” of the present invention. The image pickup apparatus 250 is a digital camera, for example, and can image or photograph the customer 22 at various angles or in various directions.

The image processor 260 is one example of the “current image generating device” of the present invention. The image processor 260 can generate the image data of the customer 22 imaged by the image pickup apparatus 250. The image processor 260 may be integrated with the image pickup apparatus 250. Moreover, if the image pickup apparatus 250 is a general silver salt camera or the like, the image processor 260 may be able to convert the externally inputted image to the image data, as in a scanner apparatus, for example.

Back in FIG. 1, the server 300 is operated on the network 10, and can transmit and receive the data, with respect to the terminal system 200 to which the server 300 is connected via the network 10. Incidentally, in the embodiment, only a user who is registered as a member (which is namely the beauty shop 20 in this case) is allowed to access the server 300. The server 300 transmits and receives the data associated with a counseling service described later, with respect to the user who is allowed to access. The allowance of the access is realized by the server 300 providing the terminal system 200 with member authentication by a user ID, a password or the like.

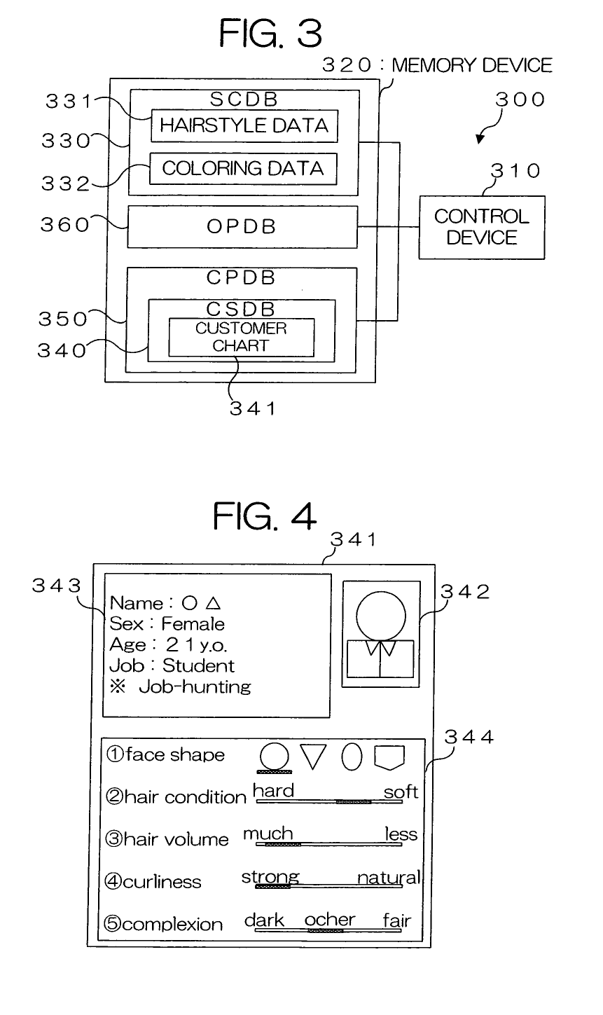

Now, with reference to FIG. 3, the detailed structure of the server 300 will be explained. FIG. 3 shows the server 300.

In FIG. 3, the server 300 is provided with: a control device 310; and a memory device 320.

The control device 310 is provided with a CPU or the like, for example, and controls the operation of the server 300. At the same time, the control device 310 functions as one example of each of the “specifying device”, the “estimating device”, the “searching device”, the “image generating device”, the “future image generating device”, the “transmitting/announcing device”, and the “date managing device” of the present invention.

The memory device 320 is built in or externally attached to the server 300. The memory device 320 is provided with: a Style Content DataBase (hereinafter referred to as a “SCDB” as occasion demands) 330; a Customer Style DataBase (hereinafter referred to as a “CSDB” as occasion demands) 340; a Customer Profile DataBase (hereinafter referred to as a “CPDB”) 350; and an OPeration DataBase (hereinafter referred to as an “OPDB”) 360.

The SCDB 330 is one example of the “database” of the present invention. The SCDB 330 stores therein a hairstyle data 331 and a coloring data 332.

The hairstyle data 331 is one example of the “plurality of hairstyle image data” of the present invention. For example, the hairstyle data 331 is several thousand types of hairstyle image data. In the explanation below, individual hairstyle image data constituting the hairstyle data 331 will be merely referred to as “hairstyle data” unless otherwise noted. In the embodiment, the hairstyle data is provided with the image data observed in four directions of the front (i.e. a face), both lateral sides, and the rear.

Incidentally, there is no limitation in the number of types of hairstyles prepared as the hairstyle data 331. Moreover, even the individual hairstyle image data may include not only the image data observed in the four directions described above, but also image data observed in various directions. Alternatively, the individual hairstyle image data may be only image data observed from the front, for example.

The coloring data 332 is one example of the “plurality of hair color image data” of the present invention. For example, the coloring data 332 is several hundred types of hair color image data. Incidentally, in the explanation below, individual coloring data constituting the coloring data 332 will be merely referred to as “coloring data” unless otherwise noted. In the embodiment, the coloring data is an image obtained by providing the coloring corresponding to the individual coloring data, for a single hairstyle image. Incidentally, the coloring data is not limited to this aspect, and may be merely color data, such as a color sample.

On the other hand, the hairstyle data 331 and the coloring data 332 are individually stored in the SCDB 330 in association with feature parameters.

The feature parameters are a plurality of parameters for indicating physical features about the head portion of the customer 22, such as a face shape, a hair condition, a hair volume, curliness, and complexion. The feature parameter about the face shape is provided with values for specifying a round shape, a heart or inverted triangular shape, an oblong shape, a square shape, a pentagon or baseball's home plate shape, and the like. About the hair condition, there is provided values for indicating the hair condition from “hard” to “soft” in stages. About the hair volume, there is provided values for indicating the hair volume from “much” to “less” in stages. About the curliness, there is provided values for indicating the hair volume from “strong” to “natural” in stages. Moreover, the feature parameter for indicating the complexion is provided with values for indicating the complexion from “dark”, “ocher”, to “fair” in stages.

The SCDB 330 stores therein the hairstyle data 331 and the coloring data 332, together with matching information for indicating which feature parameter is matching. Such a storage form is one example of the “association” of the present invention.

Incidentally, the judgment reference for defining the suitability with the individual feature parameter is based on the opinions of particular stylists who have a high sense of art and who are referred to as “charisma beauticians” in Japan. Thus, it has high objectivity. Incidentally, the judgment reference of the suitability may be set by reflecting marketing results for the general public, or maybe set by adopting a part of fashion, for example.

On the other hand, in the SCDB 330, the hairstyle data 331 and the hair color data 332 are further stored in association with the elapsed time of the individual hairstyle data and hair color data, respectively.

The elapsed time is set to intervals of 5 days, for example. Namely, for example, how the hairstyle shown as one hairstyle data will change as time passes, such as in 5 days, in 10 days, in 15 days, and the like, is prepared in advance as the image data having the same spec as that of the individual hairstyle data, and is stored as the change-over-time data of the individual hairstyle data. Incidentally, the maximum value of the elapsed time is set to about 6 months because statistically, there are very few people who do not go to beauty shops in six months. Moreover, the growth speed of hair varies depending on the individuals. It is known, however, that hair averagely grows 1 cm a month, and the embodiment substantially uses this speed as a reference. Even with respect to the coloring data, the data for indicating how the color will change as time passes, such as in 5 days and in 10 days, is prepared as the image data having the same spec as that of the coloring data, and is stored as the change-over-time data of the coloring data. Incidentally, a range of defining the change-over-time data of the hairstyle data and the coloring data varies in the hairstyle data and the hair color data.

By the way, the change over time of the hairstyle varies depending on the hair condition, the hair volume, the curliness, and the like, for example. Therefore, the SCDB 330 stores therein the change-over-time data in association with the feature parameters described above. Namely, the hairstyle shown as the one hairstyle data is associated with the elapsed time, for each hair condition, for each hair volume, or for each curliness, for example.

Incidentally, the hairstyle data 331 is not necessarily associated with all the feature parameters. For example, the hairstyle and the feature parameter about the complexion have a low correlation, so that the hairstyle may not be associated with the feature parameter about the complexion in advance.

The CSDB 340 can store therein the feature parameters and attributes of the customer 22 as a customer chart 341.

The attributes are information for indicating the lifestyle of the customer 22, such as age, sex, job, hobby, and purposes.

Now, with reference to FIG. 4, the customer chart 341 will be explained. FIG. 4 shows the customer chart 341.

In FIG. 4, the customer chart 341 is provided with: a customer image area 342; an attribute area 343; and a feature parameter area 344. In the customer image area 342, an image for identifying the customer 22, such as the face picture of the customer 22, is displayed. In the attribute area 342, the attributes described above are shown. Namely, a name, sex, age, job, date of visit, purposes, and the like are shown. In the feature parameter 344, the feature parameters described above are recorded. For example, the customer 22 shown in FIG. 4 has a round face, soft, much volume, strongly curly hair, and a standard colored skin.

Back in FIG. 3, the CPDB 350 includes the CSDB 340, and stores therein the detailed information of the customer 22, which is not displayed on the customer chart 341. In the CPDB 350, information obtained by the questionnaire survey of the customer 22 who comes to the beauty shop 20, small information obtained in the conversation during the hair treatments, or supplement information useful for business, such as an address, an email address, and the number of times of visit, can be arbitrarily recorded for each customer. Customer information stored in the CPDB 350 is linked with the customer chart 341 stored in the CSDB 340, and it is possible to easily refer to one of them from the other.

In the OPDB 360, the image data after the hair treatments of the customer 22, the simulation result and the like, which are generated in a counseling service described later, can be stored for each customer 22. Moreover, in the OPDB 360, there are also a hair treatment record, a purchase record of products at the shop, a record of visits, advice from the stylist 22, and the like.

Incidentally, the CSDB 340, the CPDB 350, and the OPDB 360 are provided for each member on the server 300. In the embodiment, basically, only the beauty shop 20 is authorized to access the information of each customer 22 stored in the above databases. Therefore, for example, even if other beauty shops unrelated to the beauty shop 20 are connected with the server 300, the server 300 does not allow the other shops to access the databases in view of security. Exceptionally, if the beauty shop 20 has chain shops, the information of the customer 22 may be shared with the chain shops on the serve 300.

<Operation of Embodiment>

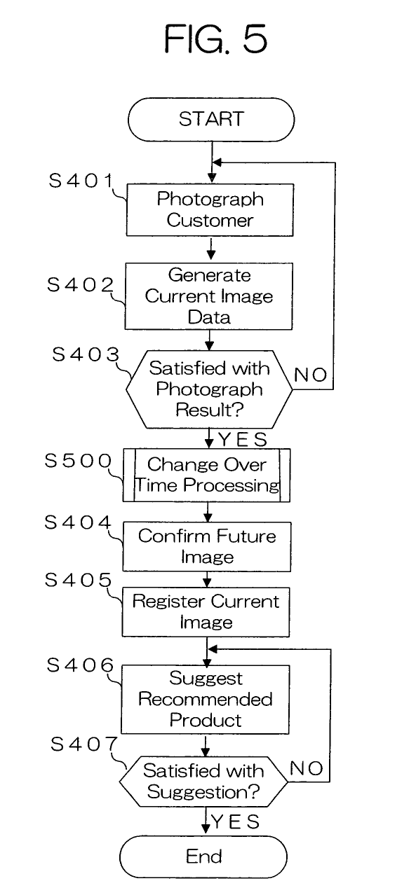

Next, with reference to FIG. 5, the operation of the hairstyle displaying system 100 will be explained with the content of a counseling service performed by using the hairstyle displaying system 100. Here, FIG. 5 shows the counseling service. Incidentally, it is considered that the customer 22 is a regular customer of the beauty shop 20 and thus the customer chart 341 is already stored in the CSDB 340. Moreover, the counseling service is performed after the hair treatments (i.e. haircut and coloring) for the customer 22.

At first, the customer 22 is photographed after the hair treatments (step S401). At this time, the stylist 21 in charge of the customer 22 takes the pictures of the head portion of the customer 22 associated with the four directions described above, and the close-up picture of the head portion for specifying the feature parameters. Incidentally, the step S401 is one example of the “image pickup process” of the present invention.

After the customer 22 is photographed, each picture is converted to image data by the image processor 260 (step S402). Incidentally, the step S402 is one example of the “current image data generating process” of the present invention. The image data of the customer 22 generated in this manner is displayed on the display device 220 under the control of the control device 210.

Then, the customer 22 judges whether or not the image of the self displayed on the display device 220 is satisfying (step S403). If the customer 22 is not satisfied with the image (the step S403: NO), the stylist 21 photographs the customer 22 again until the customer 22 is satisfied. If the customer 22 is satisfied with the image (the step S403: YES), the operational flows transmits to change-over-time processing (step S500).

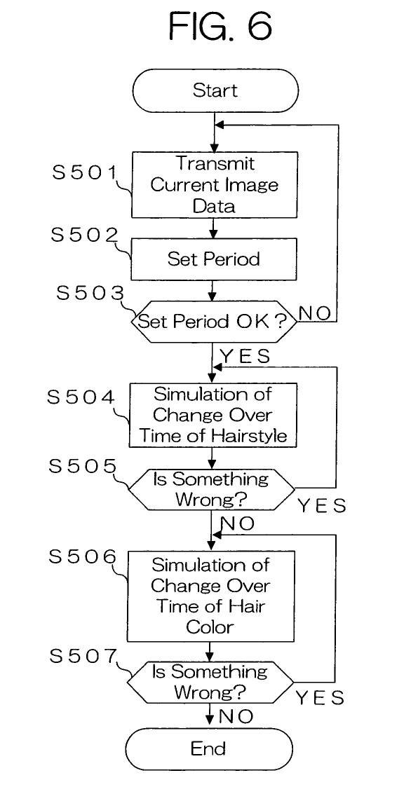

Now, the change-over-time processing will be explained with reference to FIG. 6. FIG. 6 shows the change-over-time processing.

At first, the stylist 21 inputs, from the input device 230, a request for transmitting the image data of the customer 22 (hereinafter referred to as “current image data” as occasion demands) to the server 300. The control device 210 transmits the current image data to the server 300 via the communication device 240, on the basis of the inputted request (step S501). On the other hand, on the server 300, the control device 310 specifies the feature parameters of the customer 22, from the received current image data.

Then, the stylist 21 inputs a period associated with the change over time, from the input device 230 (step S502). The customer 22 judges whether or not the inputted period is desirable (step S503). If the customer does not accept the inputted period (the step S503: NO), the stylist 21 sets a period again. If the inputted period is desirable (the step S503: YES), the simulation of the change over time associated with the hairstyle is performed (step S504).

If the hairstyle is simulated, at first, the hairstyle data which is the most similar to the hairstyle recognized from the current image data of the customer 22 is selected from the hairstyle data 331 stored in the SCDB 330 on the server 300 side. The selection may be performed by virtually generating an image in which the face portion is removed (i.e. by virtually generating an image about the hair) from the current image data of the customer 22, and by comparing it with the hairstyle data. Alternatively, if the hair treatment for the customer 22 is performed on the basis of the hairstyle data 331 stored in the SCDB 330, the relevant hairstyle data may be selected. Incidentally, the hairstyle may be simulated regardless of the hairstyle data stored in the SCDB 330. For example, the hairstyle may be simulated by virtually generating an image about the hair from the image data of the customer 22, and further by adding or growing some hair on the virtually generated image data by using a CG technique or the like. In this case, by considering the specified feature parameters, for example, by predicting and operating the change over time, in the case of soft hair or much hair volume, it is possible to perform the simulation more accurately.

If the hairstyle data is selected, the control device 310 obtains the change-over-time data, which corresponds to what the selected hairstyle data will be like after an elapse of the inputted period, from the SCDB 330, and transmits it as future image data about the hairstyle to the terminal system 200.

In the terminal system 200, the received future image data about the hairstyle is displayed on the display device 220. The stylist 21 judges whether or not something is wrong or weird with the displayed future image of the customer 22 (step S505). If the stylist 21 judges something is wrong (the step S505: YES), the stylist 21 repeats the simulation of the change over time associated with the hairstyle.

In this case, the stylist 21 can transmit detailed requests to the server 300 by using the input device 230. On the server 300 side, various types of adjustment, such as increasing the hair volume, making the hair strongly curly, finely adjusting the end of the hair, and growing the hair, is performed on the basis of the received requests. Moreover, the adjustment result is transmitted to the terminal system 200 successively. The control device 210 controls the display device 220 to display thereon the received data, by which the stylist 21 can confirm the simulation result and its process in real time.

If the stylist 21 judges there is nothing wrong in the end (the step S505: NO), then, the simulation of the change over time associated with the hair color is performed (step S506).

The hair color which is the most similar to the hair color recognized from the current image data of the customer 22 is selected from the coloring data 332 stored in the SCDB 330 on the server 300 side. The selection may be performed by the control device 310 extracting the hair color data of the customer 22 from the current image data of the customer 22 and by comparing it with color sample data prepared in advance. Alternatively, if the hair treatment for the customer 22 is performed on the basis of the coloring data 332 stored in the SCDB 330, the relevant coloring data may be selected.

If the coloring data is selected, the control device 310 selects the change-over-time data, which corresponds to what the selected coloring data will be like after an elapse of the inputted period, from the SCDB 330, and appends it to the already simulated future image data about the hairstyle. At this time point, the color appearance or color fading over time of the hair color is presented.

Moreover, the control device 310 calculates the growth of hair from the future image data about the hair style, on the basis of the comparison with the current image data. The hair is colored in the original hair color of the customer 22, by a length corresponding to the growth of hair, from the root portion of the hair on the future image data about the hairstyle, to thereby generate future image data about the hair color. The generated future image data about the hair color is transmitted to the terminal system 200.

In the terminal system 200, the received future image data about the hair color is displayed on the display device 220. The stylist 21 judges whether or not something is wrong with the displayed future image of the customer 22 (step S507). If the stylist 21 judges something is wrong (the step S507: YES), the stylist 21 repeats the simulation of the change over time associated with the hair color.

In this case, the stylist 21 can transmit detailed requests to the server 300 by using the input device 230. On the server 300 side, the adjustment of the whole color image, such as further fading the hair color, is performed on the basis of the received requests. Moreover, the adjustment result is transmitted to the terminal system 200 successively. The control device 210 in the terminal system 200 controls the display device 220 to display thereon the received data, by which the stylist 21 can confirm the simulation result and its process in real time.

If the stylist 21 judges there is nothing wrong in the end (the step S507: NO), then, the simulation of the change over time associated with the hair color is ended. Incidentally, if the customer 22 does not desire the coloring, the simulation of the hair color may be not performed. At the time point of ending the simulation of the change over time associated with the hairstyle and the hair color, the change-over-time processing is ended. Then, the final future image of the customer 22 is displayed on the display device 220 in the terminal system 200.

Back in FIG. 5 again, the customer 22 confirms the future image of what the customer 22 will be like after an elapse of the set period by using the display device 220 (step S404). By virtue of the step 404, the customer 22 does not have complaints and doubts, such as “the color is weaker than expected” and “what the hairstyle will be like in one month”, and the customer 22 can be highly satisfied.

If the customer 22 ends the confirmation, the stylist 21 operates the input device 230 and registers the current image data of the customer 22 into the OPDB 360 (step S405). At this time, the date of visit, various information about the performed hair treatments (the used hairstyle data and coloring data), advice information from the stylist 21, a purchase record of various shop-selling products, the presented future image of the customer 22 and the like are also recorded if desired.

On the other hand, on the server 300, for example, the product that is suitable for the customer 22 is searched for from the shop-selling products, on the basis of the hair treatment record of the customer 22 registered in the OPDB 360. Then, the search result is transmitted to the terminal system 200. The stylist 21 uses the search result which is transmitted from the server 300 and which is displayed on the display device 220 by the control device 210, and further suggests a recommended product or the like to the customer 22 (step S406).

The customer 22 judges whether or not the suggested content is satisfying (step S407). If there is a product to be purchased, the customer 22 purchases it and receives some advice about the purchase. In this case, for example, a comparison simulation for indicating the effectiveness in use of the shop-selling products, such as a simulation in which a perm condition lasts longer with a shop-selling hair care product than without it, may be performed by using the future image and presented to the customer 22. If the customer 22 has some complaints about the suggestion performed in this manner (the step S407: NO), the stylist 21 further requests the server 300 to search for another recommended product, or to give some more advice or the like to the customer 22. If the customer 22 is satisfied in the end (the step S407: YES), the counseling service in the embodiment ends.

Incidentally, the above-described counseling service is a service after the treatments at the beauty shop 20. According to the hairstyle displaying system 100 in the embodiment, however, it is also possible to easily suggest the hairstyle that suits the customer 22 before the hair treatments, and the hairstyle suggested in this manner may be treated by the stylist 21.

Specifically, the hairstyle data 331 and the coloring data 332 stored in the SCDB 330 have predetermined suitability with the feature parameters. Therefore, the suggestion to the customer 22 may be performed by referring to the customer chart 341 or the like to specify the feature parameters of the customer 22, and by searching for the hairstyle data which matches the specified feature parameters, before the hair treatments. In this case, if the image of suggestion is generated by removing a portion about the hair from the image data of the customer and combining the rest with the searched hairstyle data, that increases a visual effect more, which is preferable. Moreover, for example, the hairstyle or image which suits the customer 22 may be suggested after the hair treatments. In this case, the length of the hair after an elapse of the set period and the like can be calculated. At the same time, on the basis of the length of the hair and the feature parameters of the customer, the hairstyle or image which suits the customer 22 can be suggested as a hairstyle to be treated next time.

Incidentally, the image which is suggested in this manner may be stored in the OPDB 360 as the image of suggestion.

Moreover, the hairstyle displaying system 100 can be used to give such an advice that the hairstyle and the hair color are bad or not suitable, instead of saying good or suitable, before or after the hair treatments. Namely, it can be used to recommend the suitable hairstyles and hair colors to the individual customers, as well as not to recommend the unsuitable hairstyle and hair colors, individually and specifically, to the individual customers, through vision. In this case, by performing the search in a mildly set standard of the suitability, or by performing the search with the standard disregarded, it is possible to display the image of suggestion associated with the customer having the unsuitable hairstyle and hair color, and it is possible to display the future image data of what the customer 22 will be like after an elapse of the predetermined period.

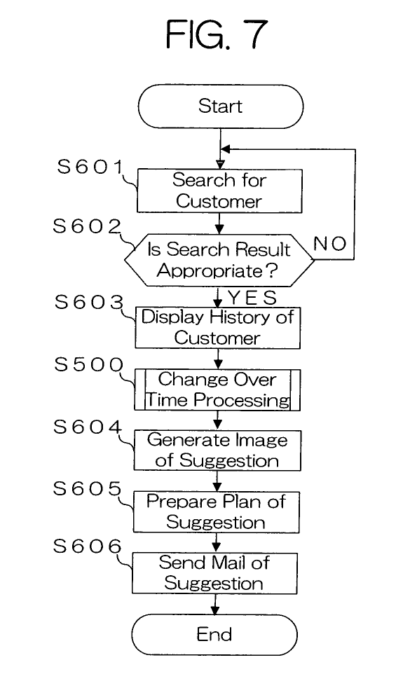

Next, with reference to FIG. 7, the further operation of the hairstyle displaying system 100 will be explained, together with the content of an aftercare service performed by using the hairstyle displaying system 100. FIG. 7 shows the aftercare service. Incidentally, in this figure, the same step as those in FIG. 5 and FIG. 6 carries the same reference numerals and the their detailed explanations are omitted.

At first, the customer 22 who haven't come to the beauty shop 20 for a predetermined period is searched for, at the beauty shop 20 (step S601). Here, the “predetermined period” is, for example, three months. The “predetermined period” can be arbitrarily inputted by the stylist 21 as a numerical value from the input device 230, and transmitted by the serve 300 to the server 300 as a search request. If the search request is transmitted from the terminal system 200, the control device 310 on the server 300 side searches for the customer 22 who haven't come to the shop for more than the inputted predetermined period since the last visit date, from the record of visits of the customer 22 stored in the OPDB 360. The search result is displayed on the display device 220 in the terminal system 200.

The stylist 21 judges whether or not the displayed list is appropriate (step S602). Namely, if the stylist 21 judges that it is not appropriate because of too much or too less search results or for the similar reasons (the step S602: NO), another search request is transmitted to the server 300 again. If the stylist 21 judges that the displayed list is appropriate (the step S602: YES), the stylist 21 selects one customer 22 from among them and displays the history of the one customer 22 on the display device 220 (step S603). Here, the “history of the customer” is an individual record of the customer 22 stored in the CSDB 340 and the OPDB 360.

Next, with respect to the customer 22, the simulation of the change over time, as already shown in FIG. 6, is performed (the step S500). In the simulation of the change over time, the period inputted in the above-described step S502 is set to an elapsed period between the last time the customer 22 came to the shop and the current time point.

The stylist 21 predicts the current hairstyle of the customer 22 by using the simulation of the change over time, and generates a single image or a plurality of images to be suggested to the customer 22 on the basis of the predicted hairstyle, as descried above (step S604).

Next, the stylist 21 prepares a plan of suggestion in which the advice and comments of the stylist 21 and the like are appended to the generated image by inputting them the input device 230 (step S605). The prepared plan of suggestion is sent as an e-mail or ordinary mail of suggestion to the e-mail address of the customer 22 stored in the CPDB 350 (step S606). The sending history is automatically recorded into the OPDB 360.

Incidentally, when the communication service is performed, a website for the communication service may be operated on the server 300 or a server different from the server 300, for example. At this time, it is also possible to operate such a website that a page is prepared for each customer 22 and that the customer 22 can arbitrarily access his or her own page.

In this case, if the generated image or plan of suggestion associated with the arbitrary customer 22 is stored in the OPDB 360 and uploaded on the website by the stylist 21 or uploaded automatically on the specified date, the customer 22 can refer to the plan of suggestion, the advice and the like in desired timing. That remarkably makes the customer 22 feel like visiting the shop. In this case, for example, in order not to prevent the stylist 21 from missing the timing of the suggestion to the customer 22 under pressure of daily work, the timing of the suggestion may be notified by automatic alert (or warning), a predetermined period after the last time of the visit, or several days before a predetermined date specified in advance (e.g. two weeks before) and the like.

In the above-described embodiment, the hairstyle displaying device 100 is a system included in the network; however, it may be a personal computer and a work station independent of the network. In this case, the above-described operations may be provided by an application program (i.e. one example of the “computer program product” of the present invention) which makes the personal computer and the work station function as the hairstyle displaying device 100.

Incidentally, the hairstyle displaying device 100 may be further provided with an outputting device, such as a printer. Moreover, it is not limited to an outputting device which uses paper as an output medium as in the printer. For example, it may be a recording apparatus corresponding to each of a magnetic recording medium, such as a FD (Flexible Disk) and a MD (Mini Disk), an optical recording medium, such as a CD-RW (Compact Disc-ReWritable) and a DVD-RAM (Digital Versatile Disc-Random Access Memory), a phase change recording medium, such as a PD, and the like. In any case, it is possible to improve the quality of the suggestion to the customer 22.

Incidentally, if the hairstyle image of suggestion about one customer 22 is generated, the beauty shop 20 independently may conduct a popularity contest through the Internet or the like, and a hairstyle having a good reputation may be adopted as the image of suggestion.

As explained above, according to the hairstyle displaying device 100, it is possible to provide the information related to the hair or the hair treatments, which is individually and specifically helpful for the customer 22, visually and accurately, before the treatments, during the treatments, immediately after the treatments, a predetermined period after the treatments, and the like.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-145094 filed on May 14, 2004 including the specification, claims, drawings and summary is incorporated herein by reference in its entirety.

1. A hairstyle displaying system comprising:
an image pickup device for imaging one customer;
a current image data generating device for generating current image data which indicates a current hair state of the imaged one customer;
a future image data generating device for generating future image data which indicates a future hair state of the one customer after an elapse of a predetermined period, on the basis of the generated current image data; and
a displaying device for displaying the generated future image data.

2. The hairstyle displaying system according to claim 1, further comprising: a database for storing therein a plurality of sample image data, which individually indicate different hair states, as a pair or a group having a relationship which corresponds to before and after the elapse of the predetermined period or a unit period, by associating before the elapse with after the elapse, one to one, multiplicity to one, one to multiplicity, or multiplicity to multiplicity,
said future image data generating device searching the database for sample image data corresponding to what the hair state shown by the generated current image data will be like after the elapse of the predetermined period, on the basis of the generated current image data, and generating the future image data on the basis of the searched sample image data.

3. The hairstyle displaying system according to claim 1, further comprising: a database for storing therein a plurality of sample image data, which individually indicate different hair states, as a pair or a group having a relationship which corresponds to before and after the elapse of the predetermined period or unit time, by associating before the elapse with after the elapse, one to one, multiplicity to one, one to multiplicity, or multiplicity to multiplicity,
said future image data generating device having an estimating device for estimating the future image data corresponding to the current image data, on the basis of the sample image data stored in the database and the predetermined period, to thereby generate the future image data.

4. The hairstyle displaying system according to claim 1, wherein said future image data generating device calculates a plurality of data elements constituting the future image data, as a predetermined function of a plurality of quantitative data elements constituting the current image data, and generates the future image data as a set of the calculated plurality of data elements.

5. The hairstyle displaying system according to claim 1, wherein
said future image data generating device is included in a network and provided for a communicable server communicable via the network,
said image pickup device, said current image data generating device, and said displaying device are included in the network and provided for a client which can communicate with the server via the network,
the server transmits the generated future image data via the network,
the client receives the transmitted future image data, and
said displaying device displays the received future image data.

6. The hairstyle displaying system according to claim 1, further comprising:
a database for storing therein a plurality of sample image data, which individually indicate different hair states, in association with feature parameters for indicating predetermined types of features associated with a hair state of an arbitrary customer;
a specifying device for specifying at least one of the feature parameters corresponding to at least one of the features associated with the future image data;
a searching device for searching for sample image data which matches the specified at least one of the feature parameters, from the sample image data stored in said first database; and
an image generating device for generating an image of suggestion to be suggested to one customer in the future, on the basis of the searched sample image data,
said displaying device further displaying the generated image of suggestion.

7. The hairstyle displaying system according to claim 6, wherein said image generating device generates the image of suggestion, on the basis of the searched sample image data and the generated current image data.

8. The hairstyle displaying system according to claim 7, further comprising:
a date managing device for managing at least a date when the one customer is imaged by the image pickup device; and
a transmitting/announcing device for transmitting or announcing the generated image of suggestion on a date or on a date and time determined on the basis of the managed date.

9. The hairstyle displaying system according to claim 8, wherein
said future image data generating device, said specifying device, said database, said searching device, said image generating device, and said transmitting/announcing device are included in a network and provided for a communicable server communicable via the network,
said image pickup device, said current image data generating device, and said displaying device are included in the network and provided for a client which can communicate with the server via the network,
the server transmits the image of suggestion via the network,
the client receives the transmitted image of suggestion, and
said displaying device displays the received image of suggestion.

10. A hairstyle displaying system comprising:
a database for storing therein a plurality of sample image data, which individually indicate different hair states, in association with feature parameters for indicating predetermined types of features associated with a hair state of an arbitrary customer;
a specifying device for specifying at least one of the feature parameters corresponding to at least one of the features associated with one customer;
a searching device for searching for sample image data which matches the specified at least one of the feature parameters, from the sample image data stored in said first database;
an image generating device for generating an image of suggestion to be suggested to the one customer in the future, on the basis of the searched sample image data,
a displaying device for displaying the generated image of suggestion; and
a future image data generating device for generating future image data which indicates a future hair state after an elapse of a predetermined period, from a hair state shown by the generated image of suggestion,
said displaying device further displaying the generated future image data at the same time of, or before or after displaying the image of suggestion.

11. A hairstyle displaying method comprising:
an image pickup process of imaging one customer;
a current image data generating process of generating current image data which indicates a current hair state of the imaged one customer;
a future image data generating process of generating future image data which indicates a future hair state of the one customer after an elapse of a predetermined period, on the basis of the generated current image data; and
a displaying process of displaying the generated future image data.

12. A computer program product in a computer-readable medium for tangibly embodying a program of instructions executable by a computer to make the computer function as a hairstyle displaying system,
said hairstyle displaying system comprising:
an image pickup device for imaging one customer;
a current image data generating device for generating current image data which indicates a current hair state of the imaged one customer;
a future image data generating device for generating future image data which indicates a future hair state of the one customer after an elapse of a predetermined period, on the basis of the generated current image data; and
a displaying device for displaying the generated future image data.

13. A computer program product in a computer-readable medium for tangibly embodying a program of instructions executable by a computer to make the computer function as a hairstyle displaying system,
said hairstyle displaying system comprising:
a database for storing therein a plurality of sample image data, which individually indicate different hair states, in association with feature parameters for indicating predetermined types of features associated with a hair state of an arbitrary customer;
a specifying device for specifying at least one of the feature parameters corresponding to at least one of the features associated with one customer;
a searching device for searching for sample image data which matches the specified at least one of the feature parameters, from the sample image data stored in said first database;
an image generating device for generating an image of suggestion to be suggested to the one customer in the future, on the basis of the searched sample image data,
a displaying device for displaying the generated image of suggestion; and
a future image data generating device for generating future image data which indicates a future hair state after an elapse of a predetermined period, from a hair state shown by the generated image of suggestion,
said displaying device further displaying the generated future image data at the same time of, or before or after displaying the image of suggestion.
